(19) United States
(12) Patent Application Publication
(10) Pub. No.: US 2007/0131084 A1
(43) Pub. Date: Jun. 14, 2007

(54) Pythagorean Fret Placement

(75) Inventor: Steven Richard Miller, Kealakekua, HI (US)

Correspondence Address: STEVEN R. MILLER, P.O. BOX 2493, KEALAKEKUA, HI, 96750, US

(73) Assignee: Steven Richard Miller, Kealakekua, HI (US)

(21) Appl. No.: 11/164,812

(22) Filed: Dec. 6, 2005

(51) Int. Cl. G10D 3/06; G10D 3/04; G10D 1/08

(52) U.S. Cl. 84/314 R

(57) ABSTRACT

This development allows Luthiers of fretted instruments an uncompensated method of installing frets with increased accuracy. It is an improvement in calculation of fret placement over the “Rule of 18”, because it relies on the length of the vibrating string. This method is more critical at the end of the fret board closest to the bridge, due to the angle formed by the string when depressed, with respect to the axis of the fret board. With respect to the twelve step octave, the scale length is multiplied by the constant of “the twelfth root of 0.5” to calculate the length of the string from fret contact to saddle contact for the next tonal step.

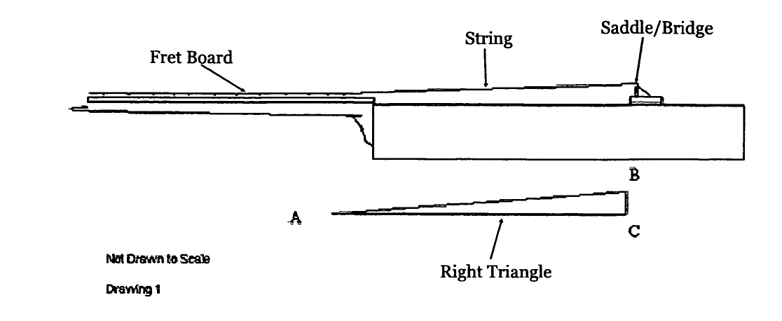

### CROSS-REFERENCE TO RELATED APPLICATIONS

U.S. Pat. No. 5/063,818 Salazar 11-1991

U.S. Pat. No. 5/404,783 Feiten 04-1995

U.S. Pat. No. 5/600,079 Feiten 02-1997

U.S. Pat. No. 5/728,956 Feiten 03-1998

U.S. Pat. No. 5/814,745 Feiten 09-1998

U.S. Pat. No. 5/955,689 Feiten 09-1999

U.S. Pat. No. 6/143,966 Feiten 11-2000

U.S. Pat. No. 6/359,202 Feiten 03-2002

U.S. Pat. No. 6/642,442 Feiten 11-2003

U.S. Pat. No. 6/870,084 Feiten 03-2005

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

This invention applies to Musical Instrument construction, specifically with respect to fret placement, and fret boards.

(2) Description of the Related Art including Information Disclosed Under 37 CFR 1.97 and 37 CFR 1.98

In the related art, it is apparent that much has been done to improve intonation through a variety of methods. Mr Feiten has pursued this to great end. To his credit, Mr. Feiten when referring to the “Rule of 18” clearly indicates that this rule is flawed. It is important to note, that in addition to the rule of 18 being flawed, the manner in which that rule was applied, is flawed as well. The Pythagorean approach as noted by Feiten, refers to the rule of 18. This is not to be confused with the work that Pythagoras did regarding the relationship of the sides of a triangle, or any other work that he did. Nor should this rule be confused with “The Pythagorean Approach to Fret Placement”, which is but a title of an invention that I have submitted that gives a nod to Pythagoras for his work. It is also important to note, that the way in which Feiten applies the rule of 18, makes it clear that the method that I am describing, illustrated by the relationship of the sides of a triangle, for fret placement, is not obvious to a person having extra-ordinary skill in the art to which said subject matter pertains. Pythagoras was, in addition to many things, an accomplished lute player who dealt with the relationship of harmonics, and the length of strings. Although the relationship of the sides of a triangle was known to have existed as much as 1000 years prior to Pythagoras, he is commonly credited with the theorems associated with the triangle. I have not seen anything to suggest that anyone has employed the relationship of the sides of a triangle to explain, why the math associated with fret placement has not been successful in achieving perfect intonation. At this point I would like to say, that Mr. Feiten has been successful in building a house on a faulty foundation. I have looked at that foundation, and have corrected the problem.

With respect to the scaling used on instruments employing 12 steps per octave, I do not subscribe to the technique of “The Rule of 18”, but rather have chosen a more direct, and logical method, that achieves the same result mathematically, but is employed differently. My approach uses the constant of the “Twelfth root of 0.5 equal to 0.94387431268 and on and on to a number in excess of 30 decimal places”. When the scale length is multiplied by this constant, the value is equal to the length of the string to move the tone to a step up. This would translate into the length of string from the tangential point of string contact at the fret, to the tangential point of string contact to the saddle. The unused or dead portion of the string/fret board is of little use or significance, since intonation is based on string length. Luthiers, those constructing fretted instruments, have employed a variety of fudge factors, and compensations to endeavor to achieve perfect intonation. Mr. Feiten in his approach has sought to employ compensation and tempering. My invention removes a variable, and explains why there is no linear relationship to a single compensation. This is not overt, nor apparent in any objective evidence with regards to anything I have read with respect to related art. There is nothing in prior art of record that points to my invention applied in any way that I have seen. I have read through the “Notice of References Cited”, and have found nothing that establishes any pre-eminence to the invention that I have submitted.

### BRIEF SUMMARY OF THE INVENTION

The invention is a method for improving placement of frets, on fretted musical instruments. It is important to note that when the string is depressed to the fret board, two things happen. First, which is commonly accepted is that the string goes slightly tighter, and ever so slightly sharp. The second thing that occurs is that the string forms a right triangle with the fret board, and the altitude of the string.

The Pythagorean approach to fret placement, and not the Pythagorean Rule of 18, refers to a method, for placing frets that addresses the concept of string vibration, and the layout of the fingerboard, not as a linear exercise in math, but as a three dimensional exercise designed to achieve improved intonation. This method is not a compensation nor is it a tempering of the strings. This application illustrates, that no one compensation can be successful in attaining perfect intonation. This is due to the mechanism at work not being linear. Briefly stated, Luthiers take a linear approach to fret placement, calculating the distance to fret placement from a fixed point along the axis of the fret board. I, on the other hand, say it is imperative to calculate fret placement along the axis of the string from the tangential point of string contact on the saddle to the tangential point of contact on the fret. The significance of this method is best illustrated by the relationship of the sides of a triangle. The traditional method will place a fret closer to the nut, while my method will place a fret closer to the saddle. To complicate things, as the fret to be calculated approaches the saddle, the angle created by the axis of the string, and the axis of fret board increases. This results in the difference between traditional fret placement and my method of fret placement increasing. This illustrates that the difference is not linear. Clearly the difference will be a function of string height, where the higher the string height above the fret board, the greater the difference in traditionally calculated frets, and my method of calculating frets.

### BRIEF DESCRIPTION OF THE SEVERAL VIEWS OF THE DRAWING(S)

Axis A-C is along the axis of the neck (refer to drawing 1). Axis A-B is along the axis of the string. Axis B-C is the calculated height of the tangential point of string contact on the saddle above the axis of the tangential point of string contact to the frets. When the distance to the first fret is calculated, the distance should be analogous to the A-B axis. With this number, and the height, B-C known, the distance AC can then be calculated using the Pythagorean Theory, or applying the use of trigonometry and the Sine, Cosine, Tangent angle tables.

### DETAILED DESCRIPTION OF THE INVENTION

For the purpose of this explanation, let us assume we are dealing with the fret placement on an instrument that employs a twelve step octave. If we start with a scale length, and multiply that scale length by a constant that is less than one, we will have the distance between two points of a shorter string, one step higher in pitch. This would be the equivalent of the first fret. If we multiply this new string length by the constant again, it would give us the string length to the second fret. If you continue this to the twelfth fret, the string length will be exactly one half the scale length. If you set up an equation, and solve for this constant, you will find that this number is best described as the twelfth root of 0.5, which is a number less than one, in excess of 30 decimal places, and for the purposes of this description will be rounded off to 0.94387431268. The rule of 18 uses a constant that is divided into the scale length, the result of which is the distance from the nut to the first fret, and subsequently from one fret to the next. This is not relevant. What is relevant is the length of the vibrating string. I contend that by multiplying the scale length by 0.94387431268, you will have the length of string necessary to achieve the next higher step in tone. Clearly the easiest way to calculate the fret position would be to have a full size drawing of the instrument, and draw a line of the required length from the tangential point of string contact on the saddle to the tangential point of string contact on the fret. I think it is important to note at this point, that not all frets are equal. Not all frets have tangential points of contact in the same position. It is also important to note, that as the fret approaches the saddle of the instrument, and the angle created by the string and the fret board increases, the tangential point of contact of the string with the fret offsets, ever so slightly. The higher the string height is above the fret board, the greater the disparity between the traditional method of fret placement, and the method that I am presenting. In addition, as the fret approaches the tail of the instrument, the angle created by the axis of the string, and the axis of the fret board increases, and as a result, the difference between the two methods of fret placement increases. In the absence of a full size drawing, one need only remember the relationship of the sides of a right triangle, using the height of the string above the fret's tangential point of contact to its tangential point of contact at the saddle as the altitude, the string length as the hypotenuse, and the axis of the fret board as the leg.

1. I claim that when the string of a fretted instrument is depressed to the fingerboard, two things occur; First, which is commonly accepted, the string becomes slightly tighter, and goes ever so slightly sharp, and second, a right triangle is formed, outlined by the axis of the fingerboard, the string, and height of the string above the tangential point of string contact with the fret, perpendicular to a tangential point of string contact at the saddle.
The Invention claimed is to calculate the position of a fret, on a fret board, by measuring the required distance along the axis of the string, where the full string length will span from the point of contact on the saddle, to the point of contact on the fret.
Claim that the method of fret placement as I have outlined, compared to the Rule of 18, will place a fret closer to the tail of an instrument, where the degree of difference in position will be a function of the height of the string, and the closeness of the desired fret to the saddle.
I claim that the method of fret placement as I have outlined, compared to the rule of 18 method of fret placement, will position a fret with increased accuracy because it is the sole method of fret placement that takes into account the basis of fret placement, which is the vibration of the string.
I claim that with respect to placing frets on a fret board for a twelve step octave, multiplying the scale length by the twelfth root of 0.5, and multiplying each successive length by the twelfth root of 0.5, will provide the necessary string distances at which to place frets.
